(19) United States
(12) Patent Application Publication
(10) Pub. No.: US 2006/0156771 A1
(43) Pub. Date: Jul. 20, 2006

(54) Locking device

(76) Inventor: Peter Hauri, Stafa (CH)

Correspondence Address: HERSHKOVITZ & ASSOCIATES, 1725 I STREET NW, SUITE 300, WASHINGTON, DC, 20006, US

(21) Appl. No.: 10/540,504

(22) PCT Filed: Dec. 18, 2003
(86) PCT No.: PCT/CH03/00831

§ 371 Date: Dec. 14, 2005

(30) Foreign Application Priority Data
Dec. 23, 2002 (CH) 2204/02

(51) Int. Cl. E05B 47/06

(52) U.S. Cl. 70/278.7

(57) ABSTRACT

The locking device comprises a coupling element (5). It can be brought into a first and a second coupling condition in an electronically controlled manner by drive means moving the coupling element. A drive-off element (4) can be connected to locking means. In the first coupling condition, the rotor is decoupled from the drive-off element in the sense that no direct coupling via the coupling element or an other coupling means is present that would mean that the rotation of the rotor would cause a movement of the drive-off element. In the second coupling condition, the coupling element couples the drive-off element with the rotor (2), which may be operated by means of a key, door handle, door knob or similar means, or by an electrical actuation.

The invention relates to a locking device for a locking system. A locking system here is to be understood as a system with mechanical elements which permits or blocks the access or entry to an object, depending on whether an authorisation exists or not. A locking device in particular permits or prevents the actuation of a lock cylinder or lock by way of turning a key or a door knob, by way of actuating a door handle or comparable means, or in an automated manner, by way of suitable drive means etc.

Locking devices with mechanically and electronically—mechatronically—controlled blocking elements are known. They have all the properties of conventional, purely mechanical locking devices. The additional electronically controlled locking furthermore permits the possibility of activating and blocking keys individually. One may thus achieve additional flexibility in the lock organisation with mechatronic locking devices.

Electronically controlled locking is based on a data transmission between an electronics module on the key side, and an electronics module on the lock side. This data transmission may take place by way of contact—for example by way of electrical contact on the key and lock—or in a contact-free manner—for example by way of electromagnetic induction. Data may be transmitted in one direction only or in both directions. In the electronics module on the lock side or on the key side, on the basis of the transmitted data, it is checked as to whether the inserted key is authorised to access. If this is the case, then a motor on the lock side is activated which moves a blocking element in an electronically controlled manner, and in a manner such that it releases the lock cylinder or the lock.

Such a locking device is for example known from the international patent application publication WO 98/28508 or from the international patent application publication WO 01/21913.

The disadvantages of such locking devices according to the state of the art is the fact that attempts at manipulation are sufficient to overcome the blocking of the lock cylinder effected by the blocking element. This may be accomplished by way of the effect of shock, by way of vibrations or brute force or in any other manner.

In order despite this to guarantee a high security, such locking devices are often combined with elements of a conventional, purely mechanical locking device with tumblers. This for example is likewise known in the mentioned documents WO 98/28508 and WO 01/21913. Such a combination entails a high operational reliability but it limits the flexibility of a system operator for the following reasons: often the accesses to an object (for example to a building) which is most relevant to safety or most frequented are provided with mechatronical/mechanical locks. However yet further locks exists which are designed in a purely mechanical manner, for example doors to individual rooms in the inside of the building. These—on authorisation—are to be opened with the same key as with the mechantronic/mechanical locks. If in an existing building locks are allocated to a first lock installation, then a combination with mechatronic/mechanical locks of a second lock installation—of the same manufacturer or another manufacturer—is not possible, which for example is disadvantageous if no mechatronic/mechanical closure system may be obtained from the first manufacturer. The same disadvantage exists if access solutions which are comprehensive with regard to the installation (which concern more than one installation) are to be found.

Generally, with existing mechatronic systems, a happy medium is to be found between the contradicting demands of security and flexibility. Often, for retaining the flexibility of access, the mechanical permutation must be designed in a simultaneously locking manner, which of course is at the expense of the security.

Mechatronic locking devices with a drive-off element decoupled from a rotor are shown in the documents EP 1 030 011, U.S. Pat. No. 5,640,862, EP 0 312 123, FR 2 801 334 and FR 2 552 809.

It would be desirable to have a locking device which is sufficiently secure in order to permit a decoupling from possibly present mechanical safety elements and possible also permit a functioning without additional safety measures by way of mechanical safety elements.

It is therefore the object of the invention to provide a mechatronic locking device which is resistant to external foreign influences, in particular to the effects of force, vibration or shock or magnetic effects, and ensures a reliable and safe functioning.

The object is achieved by a locking device and the method as are defined by the patent claims.

The locking device comprises a coupling element and a drive-off element which may be brought into active connection with bolt means. It may be brought into a first and a second coupling condition by way of electronically controlled drive means via advance means which move the coupling element. In the first coupling condition the rotor—thus the part of the lock which may be rotated by way of the key, door handle or similar means—is decoupled from the drive-off element in the context that no direct coupling via the coupling element or other coupling means is present, which would have the effect of a rotation of the rotor causing a movement of the drive-off element. In its second coupling position, the coupling element couples the drive-off element to a rotor, which may be actuated by the key, door handle, door knob or a comparable means or by an electrical drive mechanism.

This idea is fundamentally different from existing ideas according to the state of the art. In the state of the art, a coupling between the rotor and a catch for actuating the bolt is either provided in a fixed manner or may be accomplished with the simplest of means, for example by way of inserting a key-like object. In the locked normal condition, the rotor is locked with respect to the housing, whereas a release of the rotor with respect to the housing is effected with the agreement of the mechanical coding and as the case may be, the electronic coding. One must therefore decouple the rotor and housing in order to manipulate the lock.

Accordingly, the idea according to the invention differs from the state of the art in that one does not simply need to decouple the rotor and housing but one must couple the drive-off element to the rotor—and as the case may be—also must decouple it from the housing. This permits the coupling means—here the coupling element—to be selected in a very simple manner such that the coupling only comes into effect in a sole singular condition of the coupling means.

This is advantageous for the following reason:

One may assume that with attempts at manipulation, the coupling element or blocking element may be deflected out of its rest position, for example by way of knocks. This is exploited with attempts at manipulation in that one manipulates with a multitude of knocks until the blocking element is located in the free position. The locking device is simultaneously influenced such that the blocking element once situated in the free position is immediately fixed in this—for example by way of a torque acting continually on the rotor.

The requirement of the coupling being accomplished only at a unique, singular condition reduces the probability of the coupling element getting into the second coupling condition at all by way of random agitations—knocks. And even if that were once to be the case, the element would be immediately removed from this position by way of the same random agitation. Thus only a very tiny time window is available in which one may perform any manipulation. In statistical mechanics, the number of all conditions which lead to the event (successful manipulation) is compared to the number of all possible conditions. If the ratio is small, then the event is improbable. In the terminology of statistical mechanics thus the idea according to the invention provides a very small phase space for attempts at manipulation. Furthermore, it is not possible to fix the coupling element onto the rotor by way of constantly exerting a torque as soon as it is in the second coupling position, since the rotor is not coupled to the housing via the drive-off element but is freely rotatable or is fixed with another means which is independent of the coupling element.

By way of a driving-back force which has the effect that the coupling element tends to move away from the coupling position corresponding to the second coupling condition, one may even further reduce the probability of the coupling element coming into the second coupling position by chance.

The mechanical decoupling of the rotor and the drive-off element in the first coupling condition entails the advantage that the lock may also not be actuated by way of a forced rotation of the rotor. At the most the rotor rotates in an empty manner.

According to one embodiment, the drive-off element is blocked with respect to a housing in the first coupling condition. With this, it is additionally blocked from rotation.

The coupling element may have an at least partly spherical surface and for example be formed as a ball. By way of this, the number of positions in which it couples is minimised—which is advantageous—as has been described above. There then exists the requirement for the shear lines between the elements to be coupled and the equator of the coupling element to be aligned to one another. If the equator of the coupling element is above or below the shear line, the coupling element is pushed away from the coupling position by way of exerting force on one of the elements to be coupled.

Preferably, the coupling element is neither coupled to the rotor nor to the housing. The coupling element then in its second coupling position, given a rotational movement of the rotor, may also be rotated with it. For this, it lies for example in an opening which is formed by recesses in the rotor and in the drive-off element. A fixed mechanical coupling to the drive-off element also does not exist such as for example a hinge or a positive fit, but at the most a guiding by way of this recess in this drive-off element, i.e. even if the coupling element may always rotate with the drive-off element, it however is a mechanically independent element. One may envisage the rotor having to be brought back into its initial orientation before the removal of the key, thus may only be rotated by whole-number rotations.

The drive means may for example displace the coupling element between two coupling positions corresponding to the two coupling conditions. In the first coupling position the coupling element couples the housing and drive-off element whilst it effects no coupling between the rotor and drive-off element. In the second coupling position it couples the rotor and drive-off element, but effects no coupling between the housing and the drive-off element.

Alternatively to this an advance means of the drive means which serving as a blocking element may block the drive-off element with respect to the housing in a first coupling condition. In the second coupling condition the coupling element couples the rotor and drive-off element. At the same time the blocking element and the coupling element are designed and arranged such that the blocking element when it is moved from the second to the first coupling condition, simultaneously by way of a direct or indirect affect moves the coupling element away from the coupling position.

A further alternative envisages the drive-off element not being blocked with respect to the housing also in the first coupling position. This is advantageous if the drive-off element for example is rigidly connected to an inner door handle. In this embodiment, on the one hand it is ensured that a person located in the inside of the object to be closed may always leave the object. On the other hand this direct coupling between the drive-off element and the inner door handle also represents a certain amount of protection from manipulation—the inner door nevertheless still always needs to be moved with it on each attempt at manipulation.

An electric motor with a travel spindle may be used as a drive means. Electric motors are relatively modest consumers of electricity in comparison the magnet actuators. Furthermore they are largely vibration-resistant, shock-resistant and magnet-resistant due to their construction.

The coupling element may be displaceable by way of the drive means in a “quasi forcibly guided” manner or even in a completely forcibly guided manner. This means that the position of the coupling element between the first and the second coupling position is defined every time by the drive means, for example in that they are connected to the advance means of the drive means. In the case of the quasi-forcible guiding, this connection may only be released by way of a certain force effort. It may for example be the case that the advance means and/or the coupling element comprises a permanent magnetic moment and the coupling element clings to the advance means on account of this. In the case of the forcible guiding, the connection is so firm that it may not be released at all by way of normal knocks. The coupling element for example is fixed on the advance means by way of mechanical connections. The mechanical connections for example are released as soon as the coupling means are located in the second coupling position.

The locking device may thus be designed such that the coupling element is always oil one of two predefined paths: on the first path quasi-forcibly guided or forcibly guided between the first and the second coupling position, on the second path rotated along with the rotor and relative to this in a constant position about an axis of the rotor.

The drive means may be provided with spring means which are formed and arranged such that the coupling element located between the first coupling position and the second coupling position may be moved against a spring force in the direction of the first coupling position by way of a mechanical action. With this one may prevent damage due to forced manipulation attempts and with the failure of the drive. If the coupling element is located in an—undefined—position between the first and the second coupling position and force is exerted on a shear line, then the coupling element backs away in the direction of the first coupling position without damage having arisen.

The locking device—for the case that it is used with a lock cylinder—may comprise a key-blocking element which may be moved from a first position into a second position by way of introducing the key into the key opening, wherein in the second position it permits a withdrawal of the key only at defined, predefined alignments of the rotor. This on the one hand permits the user to open a door in a manner known per se in that he pulls on the key which is not directed vertically. One the other hand it may be ensured that the system with the key removed is always in a defined position in which the coupling element is displaceable between the two coupling positions. One may also envisage the key-blocking element blocking the rotor against rotation in the first position so that this may not be moved away from its defined position by way of a screwdriver or similar means or by way of randomly induced movements. With attempts to move the rotor with a screwdriver or likewise and with much force, the key-blocking element at the most becomes damaged but due to the mechanical decoupling of the rotor and the housing this is never the case for the elements which are important for the actuation of the bolt.

The key-blocking element—together with the coupling element—has the effect that in total three defined conditions are present:
1. No key is inserted: first coupling condition, and the key-blocking element blocks the rotor.
2. An unauthorised key is inserted: first coupling position, and the key-blocking element releases the rotor. The rotor is freely rotatable, but effects no actuation of the bolt. The key may only be pulled out in a defined position of the rotor.
3. The authorised key is inserted: second coupling condition, the rotor is rotatable and its rotation effects an actuation of the bolt.

The key-blocking element may for example be a toggle lever which is connected to a spring which effects a restoring force towards the first position.

The additional security which is effected by the above mentioned elements has the result that the locking device makes do for example without purely mechanically actuatable tumblers. With this, a locking device according to the invention may be combined with any type of existing closure systems and may be applied in a manner which is comprehensive with regard to installations. The locking device permits a connection of several installations and an application in several installations with a system-neutral key.

The locking device according to the invention may however of course additionally further have mechanical tumblers.

The locking device according to the invention in this embodiment is thus system-neutral: mechanical and mechatronic system components may be completely separated.

In the following, preferred embodiments of the invention are described in more detail by way of the drawings. There are shown in:

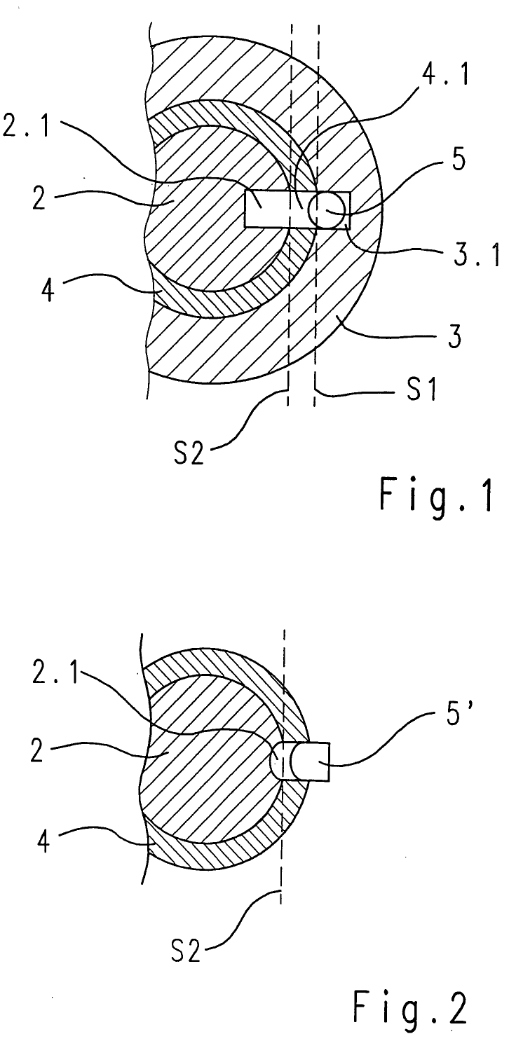

FIG. 1 schematically, a section through elements of a locking device according to the invention.

FIG. 2 likewise schematically, a section through elements of a further embodiment of a locking device according to the invention.

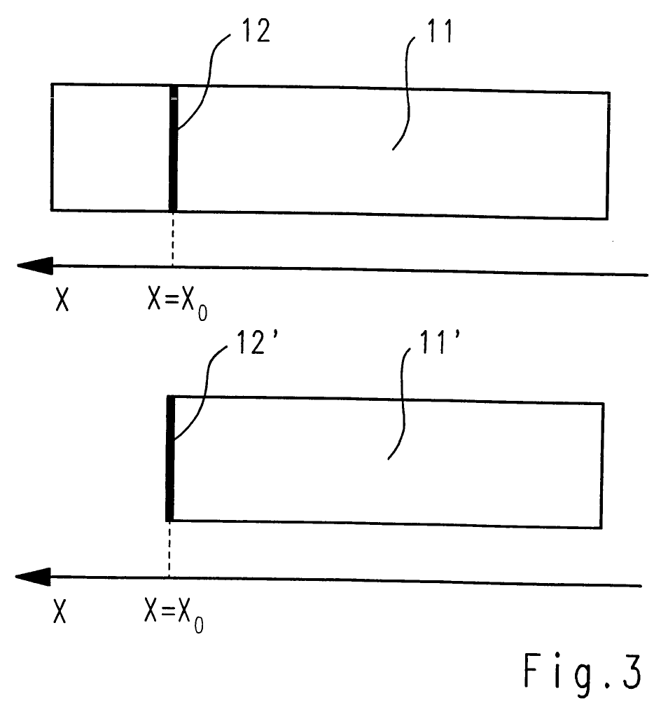

FIG. 3 schematically, the possible conditions for the coupling element in the arrangements according to FIGS. 1 and 2.

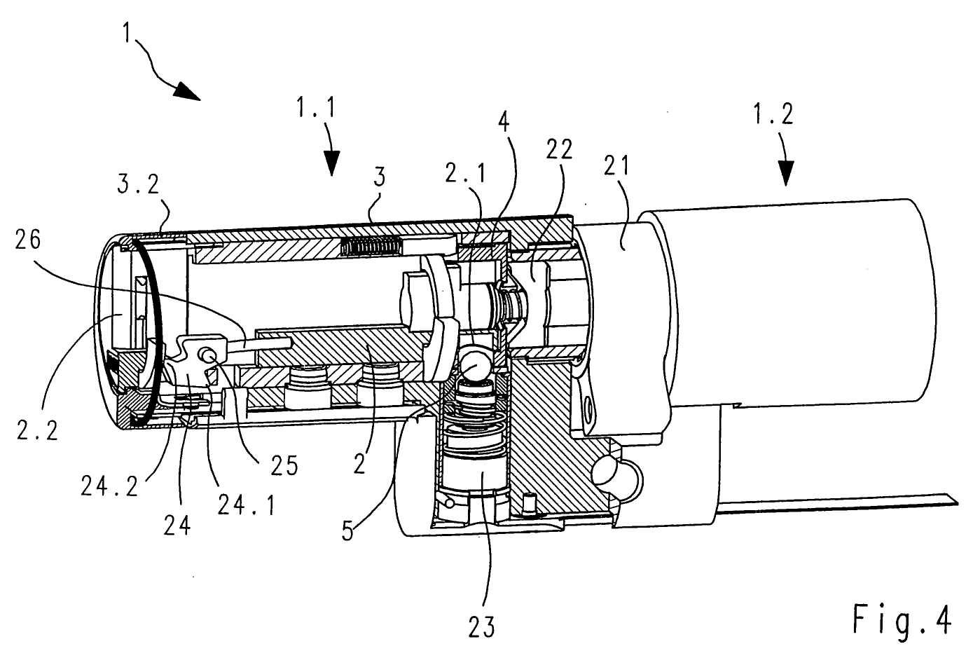

FIG. 4 a view, partly in section, of elements of a cylinder lock with one embodiment of the locking device according to the invention, wherein the coupling element is in the first coupling position

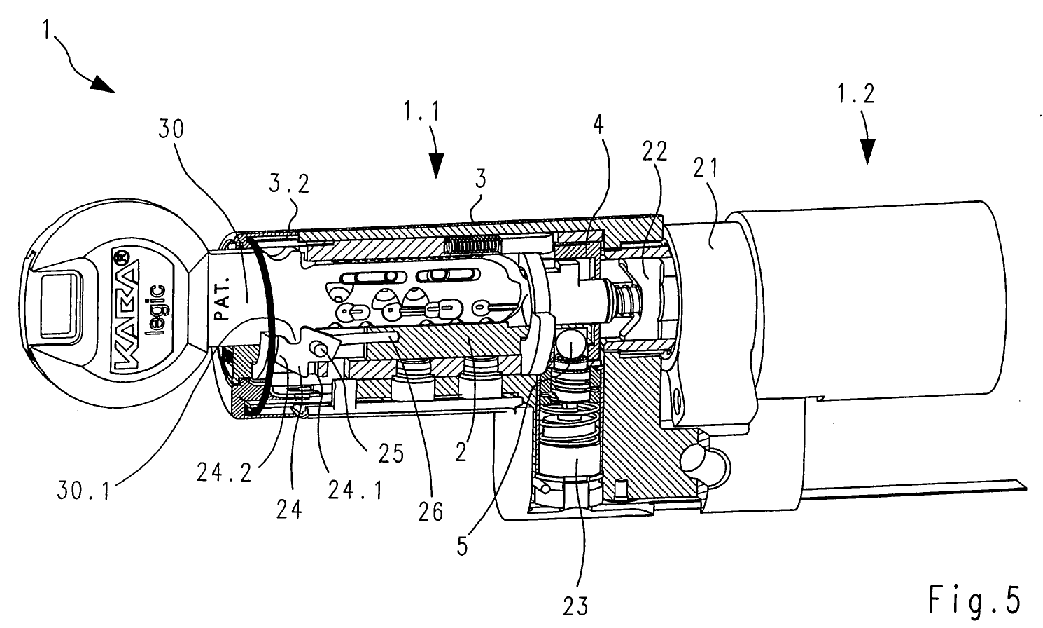

FIG. 5 the view according to claim 4, wherein a key is inserted into the key opening and the coupling element is located in the second coupling position.

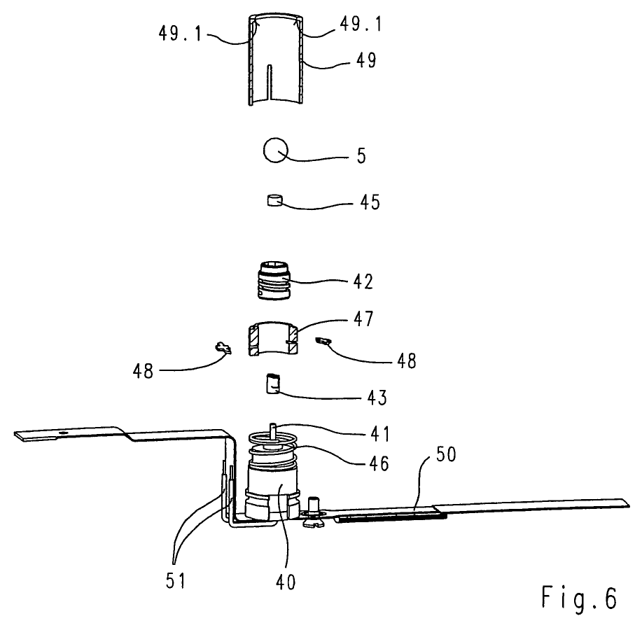

FIG. 6 an exploded representation of components of the drive means.

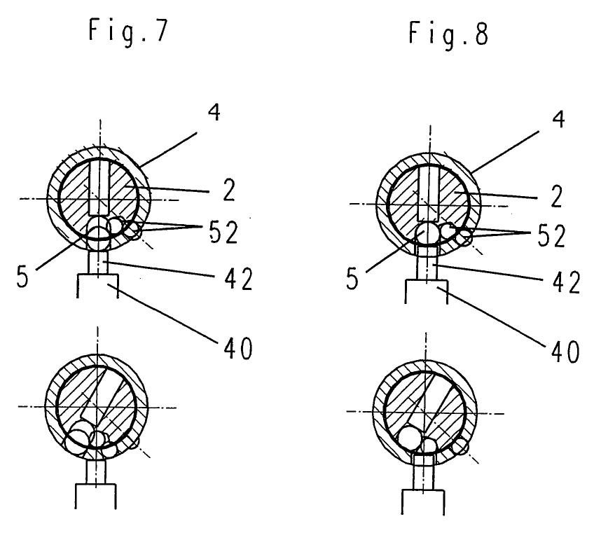

FIGS. 7 and 8 schematically, a section through a further embodiment in two coupling conditions.

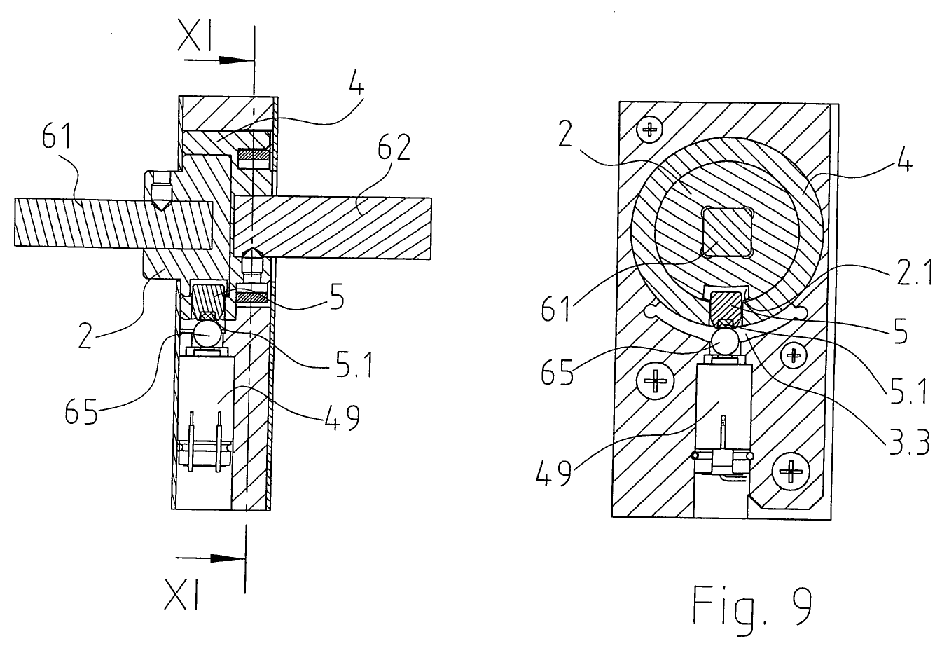

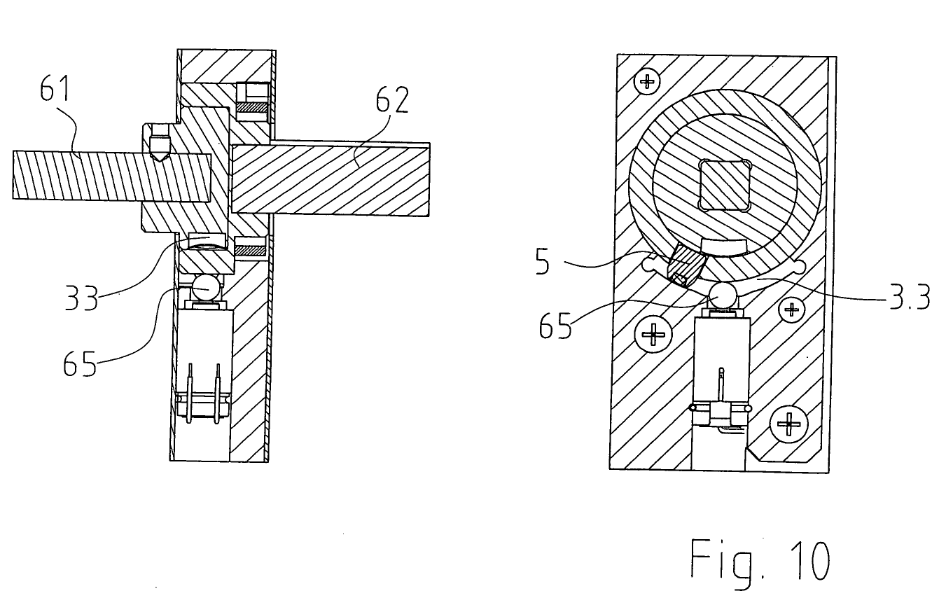

FIGS. 9 and 10 a cross section and a longitudinal section (schematically) through a lock with a locking device according to the invention, in two coupling conditions.

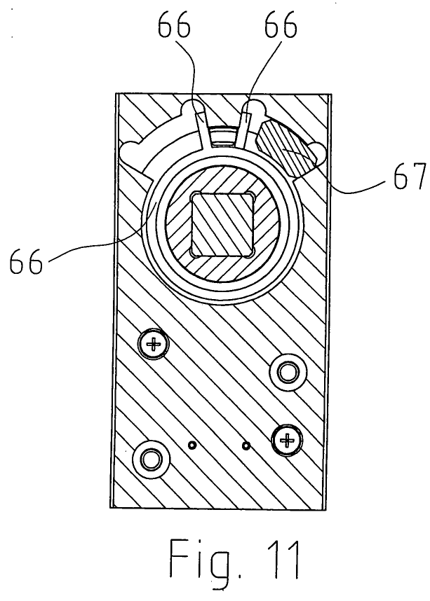

FIG. 11 a further cross section through the lock according to FIGS. 9 and 10.

A principle forming the basis of one embodiment form of the invention is shown in FIG. 1. A rotor 2 which may be rotated by way of a key and a stator 3, which is connected to a housing installed directly into a door and thus is not rotatable, are shown very schematically. A drive-off element 4 designed as a drive-off sleeve is located between the rotor 2 and the stator 3. This is at least partly rotatable about the rotational axis of the rotor and may be brought into active connection with a catch which is designed for actuating bolt elements so that the bolt—likewise, when certain conditions are fulfilled—may be actuated by way of rotation of the drive-off element 4. The rotor as well as the stator in each case have a recess 2.1, 3.1 which in the shown arrangement are flush with a recess 4.1 in the drive-off element. A coupling element 5 is located in the opening which is formed by these recesses. In the figure the coupling element is formed as a ball 5. It may also have a different shape and for example be a peg with a partly spherical surface, or a pin. The manner of functioning is the following: the coupling element may be displaced in the opening by way of drive means which are not shown. It assumes a first coupling position or blocking position—when it is located on the shear line S1 which is formed between the stator and the drive-off element. This condition corresponds to the first coupling condition. In its first coupling position, the coupling element couples the drive-off element to the stator. It prevents a rotation of the drive-off element and thus an actuation of the bolt. The coupling element however does not effect a coupling between the rotor and the drive-off element when it is in the first coupling position. The rotor and the drive-off element and thus also the rotor and the bolt are decoupled when the coupling element is located in the blocking position. This is in contrast to the state of the art where a blocking is effected in that the rotor is blocked with respect to the stator.

The coupling element 5 is in a second coupling position—or free position—when it is on the shear line S2 between the rotor and the drive-off element. This is the second coupling condition.

The arrangement shown in the figure is an example of a locking device with a coupling element 5 which in an electronically controlled manner may be displaced between a first and a second coupling position—corresponding to the first and the second coupling condition, wherein the coupling element 5, 5′ in a first coupling position blocks the drive-off element 4 with respect to the housing, and in a second coupling position couples the drive-off element 4 to the rotor 2, wherein the rotor 2 is not coupled to the drive-off element 4 when the coupling element is located in its first coupling position.

FIG. 2 shows a variant of the principle shown in FIG. 1 where the coupling element 5′ is not spherical but has a surface which is only partly spherical. The recess 2.1 in the rotor in this embodiment for example is limited such that the coupling element couples the rotor 2 and the drive-off element 4 only when it is introduced into the opening up to abutment. If the coupling element is retracted somewhat, then with a torque on the rotor, on account of its partly spherical surface it is pushed back in the direction of its first coupling position.

Instead of a hemispherical surface section of FIG. 2 one may also provide another surface shape which effects such rearward push, for example a spherical shape. The actual condition to be fulfilled in this embodiment is that the shape of the coupling element is such that it has a region in which it continuously tapers.

Of course the feature that the depth of the recess 2.1 in the rotor is limited such that the coupling element in its second coupling position is on an abutment or almost on an abutment may also be present with a spherical coupling element.

By way of FIG. 3 it is now shown how the embodiments according to FIGS. 1 and 2 contribute to the probability for a successful opening of the lock being very low and tending to zero given manipulation attempts with random movements of the coupling element.

FIG. 3 very schematically represents the amount of all conditions 11. In the arrangements of FIGS. 1 and 2, the coupling element is guided by the mentioned recesses and may only be displaced in a direction x. The conditions may also be characterised by the position in this direction x. The upper diagram of the figure shows the situation of the arrangement according to FIG. 1. The sub quantity of those conditions in which the coupling element is in its second coupling position and the opening of the lock is rendered possible is provided in the figure with the reference numeral 12. Due to the spherical surface of the coupling element, its position must be selected in a very exact manner such that its equator is located on the shear line S2. Otherwise the coupling element given a torque acting on the rotor would push away in the one or the other direction. This fact has the effect that the sub-quantity 12 of conditions in which a release is effected is very small. With random movements, the probability of the coupling element getting into the release position (the second coupling position) rapidly disappears.

The lower diagram of FIG. 3 relates to the construction according to FIG. 2. This differs from that in FIG. 1 in that the coupling element in its second coupling position is simultaneously also on an abutment. The sub-quantity 12 of conditions in which a release is effected is therefore given right at the edge. In this case too it is small in comparison to the quantity of all conditions since the coupling element is likewise pushed away from the coupling position given a torque on the rotor, when it is not positioned exactly in the coupling position.

FIG. 3 thus explains how the described measures reduce the probability of success of manipulation attempts to a very low value already due to pure statistics. Additional measures may further reduce this success probability.
1. It is ensured that with agitations of the coupling element by way of knocks, the speed of the coupling element is always large when it is in that position which corresponds to the second coupling position. In the examples described here this is effected in that the coupling element in its first coupling position is fixed with a certain force—it therefore sticks quasi in the first coupling position. It may only be removed from this at all by way of a very massive knock, and with such, the speed of the releasing coupling element is very large. In the embodiment according to FIG. 2 it is furthermore immediately reflected at the abutment and rushes back in the direction to the first coupling position. The sticking effect with which the coupling element is quasi fixed in the first coupling position may for example be effected by a ferro-magnet, but other means may also be used, for example a clamping or bonding or mechanisms similar to Velcro® closures. Further mechanisms are conceivable as for example the T-slots or swallow-tail slots for mechanical tumblers described in U.S. Pat. No. 4,103,526.
2. A retreating force as is for example described in the already mentioned publication WO 98/28508. This publication is referred to with regard to its effect. The source of the driving-back force may for example likewise be a ferromagnet.

The cylinder lock which is partly shown in the FIGS. 4 and 5 has a double lock cylinder 1 with a first part cylinder 1.1 envisaged for a door outer side, and a second part cylinder 1.2 (optional) envisaged for a door inner side. The second part cylinder 1.2 is shown in the figure only in a schematic manner. The first part cylinder 1.1 has a rotor 2 and a stator 3 surrounding this rotor. The rotor is provided with a key opening 2.2. A catch 21 is likewise shown which may be brought into connection with bar elements which are not represented. The catch 21 in a manner yet to be illustrated may be coupled to the drive-off element 4 via a winged element 22 which is to be inserted by way of introducing a key 30. An analogous means may also be provided for the possibly present second part cylinder 1.2. The winged element 22 is mechanically coupled to a drive-off element 4. This may either be coupled to housing parts or to the stator 3 or to the rotor in a manner which has already been explained. The coupling element 5 serving this purpose may be displaced by way of drive means 23 between the first coupling position (FIG. 4) and the second coupling position (FIG. 5). In the first coupling position the equator of the coupling element is located on the shear line between the drive-off element and the stator, in the second coupling position on the shear line between the drive-off element and rotor.

The drive means are electronically controlled. For the control, the cylinder lock comprises a non-represented electronics module and communication means for communication with a data carrier of the key 30. The communication means for the communication between the data carrier and the electronics module may be designed in a manner known per se for a contact-free communication via electromagnetic radiation, or the key may also comprise contacts via which contact pins of the cylinder lock may be contacted. Further communication possibilities are conceivable. The electronics module determines—for example likewise in a manner known per se—and by way of data exchanged with the data carrier of the key, whether the key is authorised to access the object. With an authorisation, the electronics module controls the drive means such that these bring the coupling element into the second coupling position and release the lock (FIG. 5). The owner of the key then with a rotation of the key may effect a rotation of the drive-off element 4, wherein the coupling element rotates along with it in the opening which is formed by recesses 2.1, 4.1 of the rotor and of the drive-off element. The drive-off element 4 via a winged element 22 and catch 21 effects an actuation of bolt elements.

A key-blocking element 24 which may be moved between a first position (FIG. 4) and a second position (FIG. 5) and is designed as a toggle lever is yet shown near to the key opening 2.2. This element is mounted on the rotor 2 by way of a rotation pin 25 and is held in its first position with spring means 26 if no further forces act. In the first position, by way of its abutment on the stator 3 it blocks the rotor 2 from rotation in a standard orientation. If a key is inserted, it may be brought into its second position counter to the spring force. The blocking of the rotor is released by way of this and the rotor may rotate freely. As soon as the rotor is no longer in its standard orientation then by way of the abutment of a first continuation 24.1 on an end face 3.2 of the stator, the key-blocking element 24 is prevented from being able to get back into its first position. At the same time a second continuation 24.2 of the key-blocking element 24 in cooperation with a projection 30.1 of the key 30 prevents the key from being able to be withdrawn.

Of course one may ensure in another manner that the coupling axis is synchronised, for example—in a manner known per se—by way of mechanical tumblers.

The drive means 23 is yet described in further detail by way of FIG. 6. It comprises an electric motor 40 by way of which a drive shaft 41 may be set into rotation. A travel spindle 42 is placed onto this drive shaft 41 in a linearly displaceable manner along this. An intermediate part 43 present between the drive shaft 41 and the travel spindle 42 is further drawn in the drawing. A permanent magnet 45 is incorporated in the screw element. An advance sleeve 47 with guide elements 48 which project through slots of the advance sleeve into helical grooves of the travel spindle 42 is mounted on the electric motor 40 with a spring 46. The electric motor with the travel spindle 42 and the advance sleeve 47 are surrounded and held by a bearing sleeve 49. The spring 46 presses the advance sleeve 47 against an abutment surface 49.1 of the bearing sleeve.

If the travel spindle 42 is set into rotation by the drive shaft, on account of the guide elements 48 projecting into the helical grooves, an advance (or retreat) onto the travel spindle 42 is effected. The travel spindle may be displaced between a first retracted position and a second position in which for example it partly projects out of the bearing sleeve and the advance sleeve 47. By way of this, the coupling element 5 in a guided manner is displaced between its first and second coupling position. If a force in the direction of its first coupling position—thus downwards in the figure—acts on the coupling element, then the coupling element 5, the travel spindle 42 and advance sleeve 47 on account of the effect of the spring 46 backs away downwards against the spring force. As already mentioned, such a force may arise on account of a torque acting on the rotor which then acts when the coupling element is between the two coupling positions.

An electricity supply cable 51 for the electronically controlled supply of the electric motor with electrical energy is shown in the figure, just as a base plate 50 leading this and possible electronic information transmission channels.

Of course the mechanism for exerting an advance described here is not the only possible manner in effecting an advance in an electronically controlled manner. The man skilled in the art would recognise many further possibilities of how to convert the rotational movement of an electric motor into an advance movement, for example by way of a screw gearing in the present case. Variants without an electric motor are conceivable, for example a magnetic actuator.

Here the role of the permanent magnet 45 is to be briefly explained. If a magnetised body is in direct contact with ferromagnetic material, the ferromagnetic domains are formed in the ferromagnetic material such that the magnetic field runs in a continuous manner in the transition between the magnetised body and the ferromagnetic material. If a short distance only separates the material and the body, such a continuous course is no longer possible and one must therefore consume energy in order to separate the material and the body. This effects something like a “sticking effect” which is known to everyone who has once played with permanent magnets. In the present case this effect is exploited in order to effect a quasi-forcible guiding. The coupling element 5 which for example contains nickel and/or cobalt may only be detached from the permanent magnet by way of massive knocks and once detached generally has a high speed. This “sticking effect” is reinforced even more if the coupling element has a flat surface as is drawn in FIG. 2. A second effect is the remote effect: the permanent magnet exerts a certain attraction force onto the coupling element 5 by which means a driving-back force arises whose advantages have already been discussed above.

The permanent magnet also permits a cylinder installation position which is rotated by for example 180° in comparison to the shown embodiment.

The embodiment shown in FIGS. 7 and 8 differ from those in FIGS. 1-2 and 4-5 in that the coupling element in the first coupling condition lies in the inside of the rotor. The blocking of the drive-off element 4 with respect to the housing is effected by a blocking element which corresponds to an advance means 42—for example a travel spindle 42 as shown in FIG. 6—and in the first coupling condition is retracted into an opening in the drive-off element. This first coupling condition is shown in FIG. 8. The coupling element 5 is located completely within a peripheral line of the rotor 2. In the first coupling condition shown in FIG. 7, the coupling element is placed such that its equator is located on the shear line between the rotor and the drive-off element 4 and thus couples the rotor and the drive-off element (second coupling position) The travel spindle 42 is retracted in this second coupling condition so that the drive-off element is rotatable. An inner and outer holding element 52 is also drawn which have the effect that the coupling element also remains in the second coupling position when the rotor is rotated and for example the gravity (with a rotation about 180°) would move the coupling element towards the inside of the rotor.

The manner of functioning of this embodiment is the following: in the first coupling condition (FIG. 8) the travel spindle 42 blocks the drive-off element 4 with respect to the housing. The coupling element does not prevent a rotation of the rotor if no other means (key-blocking element or likewise) prevent a rotation of the rotor. This then may rotate in a free manner but without any effect (FIG. 8, lower picture). A transition into the second coupling condition for example is only possible if the system is in the aligned orientation according to FIG. 8, upper picture, which again may be effected by a key-blocking element. On transition, the travel spindle is retracted in an electronically controlled manner, by which means the movement of the coupling element into the second coupling position is effected, for example by way of gravity, a magnetic force as according to the previous examples and/or a spring force which acts on the outer of the holding elements 52 and is transmitted further by this via the inner holding element. In the second coupling condition the rotor is rotatable and the drive-off element is coupled to it; the bolt may be actuated. The outer holding element 52 is located—for example pressed-in initially by a spring force—within an outer peripheral line of the drive-off element and, when the drive-off element is rotated away, is held within this outer peripheral line by way of the housing or stator. By way of this, via the inner holding element 52, it has the effect that the coupling element 5 backs away to the inside.

The transition from the second into the first coupling condition is possible only in the aligned orientation drawn in the upper picture of FIG. 7. The travel spindle presses the coupling element into the inside of the rotor and at the same time blocks the drive-off element with respect to the housing. The holding elements 52 are displaced outwards, wherein in this orientation a suitable recess is present for the outer holding element where it for example is pressed-in counter to the mentioned spring force.

In place of the drawn-in holding elements, other mechanisms are also conceivable which prevent the sliding of the coupling element into the inside of the rotor.

Although it has been shown in the FIGS. 4 and 5 how the locking device is installed into a cylinder lock, it is to be understood that the principle may also be applied in other types of locks. One example is drawn very schematically in FIGS. 9, 10 and 11. Elements which have already been described by way of FIGS. 1, 2, 4 and 5 have the same reference numerals and are not described here once again; the manner of action which has already been explained is not explained once again.

The rotor is connected directly to a door handle or to a similarly acting means or to a door knob for example in that a shank 61 of the door handle or of the door knob is designed in a rectangular manner and engages into a corresponding opening in the rotor. The drive-off element is often attached on an axis which in the installed condition lies over an axis of a lock cylinder and over the bolt means. Then suitable (not shown) coupling means are present which couple the drive-off element with bolt means which lie therebelow. On the other hand the axis of the door knob often corresponds to the axis of the lock cylinder replaced by the door knob.

The locking device is drawn in the second coupling condition in FIG. 9. The coupling element 5 projects into a recess in the rotor and by way of this couples the rotor and the drive-off element.

The drive-off element 4 may be directly connected to a door handle on the inner side or means acting in a similar manner (only a rectangular shank 62 is shown). As the case may be the drive-off element in the first coupling condition is coupled to the housing 3 which leads to a blocking of the door handle on the inner side. Alternatively a channel (hollow) 3.3 in the shown example is provided in the housing which forms a slotted piece and in which the coupling element 5 located in the first coupling condition together with the drive-off element 4 may move between two abutments without the rotor rotating as well (FIG. 10). Alternatively to this, in the first coupling condition the coupling element 5 may for example lie such that it does not couple the drive-off element with the housing in that it is retracted to such an extent that it no longer projects into the opening of the drive-off element. By way of this optional coupling variant of the drive-off element and the inner door handle with a simultaneous decoupling from the housing, one may ensure that a person located in the inside of the object to be closed may leave the object under all conditions. Furthermore the coupling of the inner door handle to the drive-off element likewise represents a certain obstacle with attempts at manipulation.

In the shown embodiment the coupling element 5 is not designed spherically but in a peg-like manner. Here it is not magnetic as a whole but at its lower side comprises an insert 5.1 of ferromagnetic material, for example of permanent-magnetic material. An intermediate element 65 of magnetic material, which here is spherical, is located between the travel spindle 42 (or the permanent magnet 45) and the coupling element 5. The intermediate element 65 has the following functions: by way of its at least regional spherical surface and the contact surfaces which are only point-like due to this, it prevents rotational movements being transmitted from the travel spindle to the coupling element by which means frictional losses would arise. Furthermore in the shown embodiment the drive means may also be brought into the second coupling condition when the drive-off element and the coupling means are not in the initial position, for example on account of a partial actuation of the inner door handle or means acting in a similar manner. This is represented in FIG. 10. With a return movement of the drive-off element and coupling means into the initial position or account of the action of a spring, the surfaces of the intermediate element 65 and coupling element 5 have the effect that the coupling element 5 is displaced upwards and engages into the recess 2.1 of the rotor, thus directly into the second coupling position.

The locking device according to the invention is particularly advantageous with a direct active connection between the door handle or the door knob and the rotor, since particularly large torques may be exerted by these means. The decoupling of the rotor 2 and drive-off element 4 according to the invention in the first coupling position here is therefore particularly advantageous.

A section through the line XI-XI in FIG. 9 is yet drawn in FIG. 11. One may recognise a spring 66 for setting back the drive-off element (and as the case may be of the inner door handle or element acting in a similar manner) and an abutment element 67, which is designed as a simple insert part and permits a resetting between an operation manner with a rotation in the anti-clockwise direction and an operation manner with a rotation in the clockwise direction.

One may yet optionally provide a—possibly conventionally mechanically functioning—lock cylinder additionally to the locking device for the door handle or door knob.

1-18. (canceled)

19. A locking device
with a housing and a rotor,
the locking device comprising a coupling element and an electronically controlled drive connected to the housing, the drive comprising an advance element, the drive being operable to move the coupling element by way of moving the advance element, and to thereby bring the locking device into a first and into a second coupling condition,
the locking device further comprising a drive-off element for actuating a locking bar, wherein in the first coupling condition, the coupling element is positioned such that the rotor is not coupled to the drive-off element,
wherein in the second coupling condition, the coupling element is positioned such that it couples the drive-off element to the rotor,
and wherein the coupling element is decouplable from the drive in a manner that in the second coupling condition it is movable away from the advance element by way of a rotational movement of the rotor.

20. The locking device according to claim 19, wherein the coupling element has an at least partly spherical surface.

21. The locking device according to claim 20, wherein the coupling element is ball shaped.

22. The locking device according to claim 19, wherein the coupling element is neither fixedly coupled to the housing nor fixedly coupled to the rotor.

23. The locking device according to claim 22, wherein the coupling element in its second coupling position given a rotational movement of the rotor is rotated in an opening which is formed by recesses in the rotor and in the drive-off element.

24. The locking device according to claim 19, wherein the coupling element and the advance element are couplable to each other by a ferromagnetic interaction.

25. The locking device according to claim 19, wherein the drive comprises a rotational drive and a travel spindle.

26. The locking device according to claim 19, wherein the first coupling condition corresponds to a first coupling position of the coupling element with respect to the rotor, and wherein the second coupling condition corresponds to a second coupling position of the coupling element with respect to the rotor, and wherein the drive comprises a spring excerpting, if the coupling element is located between the first coupling position and the second coupling position, a spring force on the coupling element, such that the coupling element may be moved against the spring force in the direction of the first coupling position by way of mechanical action.

27. The locking device according to claim 19, wherein in the first coupling condition the drive-off element is blocked with respect to the housing and in the second coupling condition the drive-off element is not coupled to the housing.

28. The locking device according to claim 27, wherein in the first coupling position the coupling element blocks the drive-off element with respect to the housing.

29. The locking device according to claim 27, wherein in the first coupling position a blocking element blocks the drive-off element with respect to the housing, wherein the blocking element and the coupling element are arranged such that a movement of the blocking element on transition between the first and the second condition causes a movement of the coupling element.

30. The locking device according to claim 19, for use in a lock cylinder being free of purely mechanically actuatable tumblers.

31. The locking device according to claim 19 for use in a lock cylinder, further comprising mechanical tumblers for engaging into recesses of a key.

32. The locking device according to claim 19, for use in a lock cylinder, further comprising a key-blocking element which by way of introduction of a key into a key opening may be moved from a first position into a second position, the key-blocking element permitting in the second position a withdrawal of the key only at certain defined alignments of the rotor.

33. The locking device according to claim 32, wherein the key-blocking element in its first position it blocks the rotor against rotation.

34. The locking device according to claim 19 for use with a door handle or door knob wherein the rotor may be coupled to an outer door handle or door knob, wherein the drive-off element is couplable to an inner door handle or door knob and that the coupling element in a first coupling condition is arranged such that the drive-off element is not blocked.

35. The locking device according to claim 34, wherein a channel is formed in a region of the housing which guides the drive-off element, in which channel the coupling element is movable by way of a rotation of the drive-off element when it is located in the first coupling condition.

36. The locking device according claim 19, comprising an intermediate element with an at least partly spherical surface, which is arranged between the advance element of the drive and the coupling element.

37. The locking device according to claim 19, wherein the coupling element comprises an insert of a ferromagnetic material.
